(19) United States
(12) Patent Application Publication
(10) Pub. No.: US 2008/0057215 A1
(43) Pub. Date: Mar. 6, 2008

(54) METHOD OF INCREASING PUNCTURE STRENGTH AND HIGH VOLTAGE CORONA EROSION RESISTANCE OF MEDIUM VOLTAGE POLYMER INSULATORS

(76) Inventor: Norman McCollough, Sharon, NH (US)

Correspondence Address: PATENT GROUP;C/O DLA PIPER US LLP, 203 N. LASALLE ST., SUITE 1900, CHICAGO, IL, 60601, US

(21) Appl. No.: 11/466,151

(22) Filed: Aug. 22, 2006

(51) Int. Cl. B01J 19/08; B05D 5/12; B05D 1/04

(52) U.S. Cl. 427/457; 427/458; 427/58

(57) ABSTRACT

Medium voltage polymer insulators coated with semi-conducting refractory paint exhibit higher puncture strength and better corona erosion (corona cutting) resistance than a typical non-coated polymer insulator. The refractory semi-conducting paint is surface bonded to the ends of the polymer chains via electron beam reactive processing methods resulting in a mechanical bond on a molecular level to the polymer chain.

### BACKGROUND OF INVENTION

1. Field of Invention

The present invention is generally related to an improved medium voltage (5-69 KV) polymer insulator. More specifically, the invention covers a method of increasing the puncture strength and high voltage corona erosion resistance of such insulators.

2. Background and Prior Art

Polymer insulators have historically proven commercially viable as a replacement for porcelain insulators in electric utility distribution systems. One problem with a polymer insulator is resistance to corona erosion (corona cutting) in high voltage applications. Corona discharge is caused by the ionization of gas molecules in a strong electric field. As such, precautions must be taken to prevent the onset of a corona discharge. Otherwise ions and free radicals generated in corona reactions will rapidly erode away or destroy organic materials such as binder resins and polymer films—resulting in corona erosion or cutting. Such corona erosion of organic materials in the insulation may be regarded as one of the initial steps leading to failure of the insulator.

Another problem is the high voltage puncture strength of the polymer insulator. Although the volume resistively of polymers is high, geometry can affect the major failure mode contributors of puncture and corona cutting. The ANSI required insulator geometry is well known to those versed in the art and generally specifies the mechanical thicknesses of the top, neck, and leakage distances portions of the insulator. The puncture is thus affected if these parts are too thin. Puncture strength is the KV rating at which an insulator will physically obtain a hole either in the top or neck of the insulator from the conducting test surface to the grounded pin in the insulator. This is a failure of the insulator and the insulator can no longer provide a high voltage insulation mode for an electric utility conductor carrying said high potential must be replaced to prevent any short on the conductor.

Paints have typically not bonded to polymers due to the polymer not normally bonding with the paint materials and hence having no chemical or mechanical bond strength would wipe, or wash off the insulator in normal use in the field. A reactive refractory paint coating will actually allow a chemical and mechanical bond of the material to the polymer molecules such that the coating will not wash or wipe off the polymer. This method has a reactive component of the paint to facilitate the bonding of the ends of the polymer chains.

### SUMMARY OF INVENTION

The present invention is directed to an improved medium voltage insulator that exhibits increased puncture strength and resistance to high voltage corona cutting by spreading charge over a specified conductor contact area on the insulator. The refractory semi-conducting paint and reactive method to bond the painted materials to the polymers has not been used in the manufacture of polymer insulators.

The refractory semi-conducting coating is strategically placed on the pin-type polymer insulator prevents localized high intensity electric field areas by charge spreading the voltage over a wide area on the insulator. The mechanical contact of the electrical high voltage conductor and semi-conducting painted area on the polymer insulator completes the electrical circuit connection. This provides an area of equal voltage potential and constant voltage gradient on the semi-conducting painted surface to prevent corona inception. The area of equal potential is thus independent of the conductor diameter or the diameter of a tie wire if used to hold the conductor to the insulator.

The reduction of corona at typical voltages reduces or eliminates corona erosion (corona cutting) of the polymer material.

### BRIEF DESCRIPTION OF THE DRAWING

FIG. 1. is a perspective view a polymer insulator, treated pursuant to the inventive method.

### DETAILED DESCRIPTION OF THE PREFERRED EMBODIMENTS

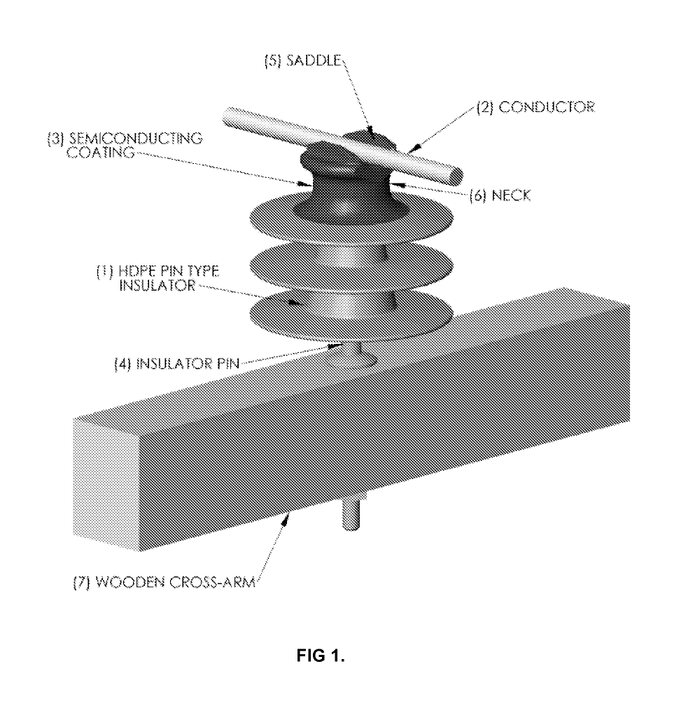

In a typical field installation, as shown in FIG. 1, the polymer insulator (1) is mounted to an electric utility cross arm (7) attached to a typical utility pole by a metal mechanical mounting insulator pin (4).

In one embodiment of the invention, the polymer insulator (1) is a pin-type high-density polyethylene (HDPE) coated with a semi-conducting layer (3) consisting of a SiO2 (silicon dioxide) and carbon black paint in the neck (6) and saddle regions (5) of the polymer insulator (1). During manufacturing of the insulator, the semi-conducting layer is activated in a plasma chemical reactor to bond the SiO2-carbon black to the ends of the HDPE molecular chains. The plasma chemical reactor consists of an Ar/O2 plasma chamber and an electron beam of sufficient energy to activate the surface refractory semi-conducting paint coating. Insulators are thus processed in the chemical reactor as one step in the manufacturing process of the polymer insulator.

The refractory semi-conducting coating strategically placed on the neck (6) and saddle area (5) of the pin-type polymer insulator (1) prevents localized high intensity electric field areas by charge spreading the voltage over a wide area on the insulator (i.e. the SiO2:carbon black painted area). The mechanical contact of the electrical utility high voltage conductor (2) and semi-conducting painted area (3) on the polymer insulator (1) completes the electrical connection to the utility supply voltage. The semi-conducting region of the polymer insulator provides an area of equal voltage potential and constant voltage gradient on the semi-conducting painted surface (3) to prevent corona inception. The reduction of corona at typical voltages reduces or eliminates corona erosion (corona cutting) of the polymer material.

The insulator thus coated performs electrically as a parallel plate capacitor having a dielectric material separating the two conducting plates. As such, the insulator thus coated may be modeled as a further confirmation of the insulator electrical performance of the preferred embodiment. This mathematical model allows using Finite Element Analysis tools to optimize the placement of the surface paint materials for optimal insulator electrical performance. The total capacitance, and hence the amount of charge stored may be calculated and verified by actual measurement.

The mathematical model of the polymer insulator and semi-conducting coating is a parallel plate capacitor formed by the semi-conducting layer (3) top plate on the polymer insulator, the polymer insulator (un-coated areas) (1) dielectric area and the metal mounting insulator pin (4) bottom plate. The charge stored is given by well-recognized equations outside the scope of this application.

The difference in the capacitance formed by semi-conducting coated (4) area and a non-coated insulator represents the change in capacitance and hence the charge storage of the insulator. The increased charge storage of the semi-conducting coated polymer insulator allows for increased puncture strength of the coated insulator. The exact charge difference depends on the actual geometry and voltage class rating of the polymer insulator.

While a particular embodiment of the present invention has been shown and described, modifications may be made. For example, for those skilled in the art, other materials such as fluorinated ethylene propylene (Teflon FEP), polyimide (Kapton HN200) cross linked bimodal high density polyethylene and linear low density polyethylene HDPE:LLDPE (XLHDPE) and polyethylene terephthalate (Mylar) are suitable insulating materials and will bond with other refractory materials such as Al2O3 (aluminum oxide). Carbon black or another semi-conducting material is held in matrix with the refractory coating material to form the semi-conducting paint material. The refractive coating material used determines the exact percentage of carbon black or other semi-conductive material.

Additionally, the insulator is not limited to pin-type insulators. Those familiar with insulator types will recognize direct application of the method and process to polymer vise-top insulators, polymer line post insulators, and other polymer insulator types.

As stated above, and re-stated here, the coated polymer insulator may be mathematically modeled. The mathematical model of which is a capacitor the upper plate or electrode being formed by the semi-conducting layer on the surface of the polymer insulator, the dielectric material being made up of the polymer insulator (un-coated areas) and the bottom plate or electrode being the metal mounting insulator pin. The charge stored by the insulator is given by well-recognized equations to those skilled in the art.

It is the difference in capacitance of an insulator with no semi-conducting coated area and an insulator with a semi-conducting area that represents the change in capacitance and hence the charge storage of the insulator. The increased charge storage due to this difference in electrode area allows for increased puncture strength by use of the refractory semi-conducting coated insulator.

The foregoing describes an improved medium voltage polymer insulator by use of a semi-conducting refractory paint and process to bond the paint to the polymer and has been provided by way of introduction. In addition to the structures, sequences, and uses immediately described above, it will be apparent to those skilled in the art that other modifications and variations can be made the method of the instant invention without diverging from the scope, spirit, or teaching of the invention. Therefore, it is the intention of the inventor that the description of instant invention should be considered illustrative and the invention is to be limited only as specified in the claims and equivalents thereto.

I claim:

1) The method of coating a polymer insulator having neck and saddle areas on an interior surface with a semi-conducting refractory paint and activating said paint in a chemical reactor to bond said reactive paint material to the polymer molecules, the method comprising,
a) coating the neck and saddle areas on the insulator surface with a semi-conducting paint;
b) placing the coated insulator in a chemical plasma reactor wherein said reactor being a chamber of sufficient volume to contain said insulator and having an Argon-Oxygen (Ar/O2) atmosphere; and
c) energizing said chamber with an electron beam of sufficient energy to cause the reaction the semi-conducting chains with the polymer molecule chains,
whereby the semi-conducting coating allows electric charge spreading on the top and neck of the polymer insulator to lower the electric field gradient due to the voltage on the conductor to prevent localized high electric field areas on the insulator that allow corona initiation and lowers the electric field preventing corona erosion of the polymer

2) The method of claim 1 wherein the step of coating is selected from the group of steps comprising spraying, dipping, and painting.

3) The method of claim 1 wherein semi-conducting paint comprises SiO2 and carbon black.

4) The method of claim 3 wherein combining SiO2 with sufficient carbon black forms a semi-conducting refractory paint exhibiting a surface resistivity of approximately 3 million ohms.

5) The method of claim 1 wherein the polymer insulator is formed from high density polyethylene (HDPE).

6) The method of claim 1 wherein the reaction in the an Argon-Oxygen plasma chemical reactor to bond said paint to the ends of the HDPE molecular chains is for a time between two second and two minutes.
